(19) United States
(12) Patent Application Publication
(10) Pub. No.: US 2006/0145666 A1
(43) Pub. Date: Jul. 6, 2006

(54) Device and method for charging an OTG portable device

(75) Inventor: Chun-Chen Liu, Taipei City (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 11/177,422

(22) Filed: Jul. 11, 2005

(30) Foreign Application Priority Data
Dec. 31, 2004 (TW) 93141685

(51) Int. Cl. H02J 7/00

(52) U.S. Cl. 320/138

(57) ABSTRACT

The present invention discloses a device and method for charging an OTG portable device, which is capable of charging the OTG portable device no matter it is acting as an OTG A-Device or as an OTG B-Device since the OTG portable device is able to change the status of the charging device thereof according to an operation performed by a control unit thereof for detecting whether there is a power signal provided from a Vbus of an apparatus connected to the I/O port of the OTG portable device, and consequently, the means for charging the OTG portable device of the invention are diversified.

### FIELD OF THE INVENTION

The present invention relates to a device and method for charging an OTG (On-The-Go) portable device, and more particularly, to a charging device and method capable of making an evaluation to determine whether to charge an OTG portable device by a control unit thereof.

### BACKGROUND OF THE INVENTION

Recently, more and more consumers and corporate users need to connect their mobile devices to each other and to various peripherals. This is confirmed by dozens of connectivity methods used by different mobile product manufacturers including proprietary docks, dongles, slots, connectors and 7 different memory card technologies. To move past this state of chaos, several mobile phone, PDA, and mobile product manufacturers have collaborated to develop a set of enhancements for the popular USB specification so that it can be used for mobile applications. The result is USB On-The-Go (OTG). USB OTG is a new supplement to the USB 2.0 specification. It augments the capability of existing mobile devices and USB peripherals by giving them a limited host capability for connection to other USB peripherals.

One of the important features of USB OTG is that the standard does not require a host PC in order for the devices to communicate. USB OTG devices, known as dual-role peripherals, can act as limited hosts or peripherals themselves depending on how the cables are connected to the devices, and they also can connect to a host PC (personal computer). The USB OTG is an extension of the USB 2.0 specification for connecting peripheral devices to each other. USB OTG products can communicate with each other without the need to be connected to a PC. For example, a digital camera can connect to a PDA, or a mobile phone can connect to a printer or a scanner, as long as all the devices are USB OTG-compatible.

USB OTG specification introduces a point-to-point connection capability for portable devices where low power consumption is essential. In a PC-centric environment, a host PC is used for providing power to the USB peripherals connected thereto. While many USB-enabled products frequently use USB for charging, the USB specification strictly prohibits this act. Yet, that hasn't stopped a plethora of uncertified products from doing just that. From a consumer perspective, portable OTG products, when connected to each other, may act like power vampires and try to drain each other's battery. As a host in an OTG system, a mobile phone must provide at least 8 mA, generally sufficient to power only a small keyboard. If a battery-powered OTG product supplies much more than 8 mA, then the battery will likely drain quickly, powering itself and the peripherals connected thereto.

Up until now, the charging of the battery of an OTG device, which can be either a USB host (OTG A-device) or USB peripheral (OTG B-device), is accomplished by connecting the OTG device to a power source through an adapter. Neither the OTG A-Device nor the OTG B-Device is capable of making an evaluation to determine whether an apparatus connected thereto is another USB enabled device with/without OTG capability or a PC, so that the battery of either the OTG A-Device or the OTG B-Device can not be charged using the power provided from the Vbus of the apparatus connected thereto.

For instance, as an USB OTG embedded digital camera acted as an OTG A-Device is connected to an USB enabled printer acted as a peripheral, the images stored in the digital camera can be transmitted to the printer directly so as to be printed therefrom. Moreover, during the process of image transmission, it is noted that the power required for the transmission process is provided from the digital camera. On the other hand, when an USB enabled PC acted as a host is connected to the USB OTG embedded digital camera, which is now acted as an OTG B-Device, for accessing the images stored therein, the power of the battery of the digital camera is still being exhausted and can not be charged by the power provided from the PC since the digital camera can not detect whether the host to which it is connected is a PC or not. Thus, while a large amount of images are being transfer from the digital camera to the PC, the battery of the digital camera are more than likely to drain during the time consuming process.

Therefore, the present invention provides a device and method for charging an OTG portable device not only by the use of an adapter, but also by using the power provided from a Vbus of another USB enabled apparatus such as a PC.

### SUMMARY OF THE INVENTION

In view of the disadvantages of prior art, the primary object of the present invention is to provide a device and method for charging an OTG portable device not only by the use of an adapter, but also by using the power provided from a Vbus of another USB enabled apparatus such as a PC.

To achieve the above object, the present invention provides a device for charging an OTG portable device, comprising: a switch, for receiving a plurality of power signals from various external power sources and selectively outputting a power signal selected form the plural power signals; a charging circuit, for receiving the power signal outputted from the switch while using the same for charging a battery of the OTG portable device; a control unit, for receiving an external data signal so as to control the selecting of the switch accordingly.

In a preferred embodiment of the invention, the power signal can be provided from an adapter, or can be provided via a Vbus, which is embedded in a personal computer or another OTG portable device.

To achieve the above object, the present invention provides a method for charging an OTG portable device, comprising the steps of:
making an evaluation to determine whether a Vbus is embedded in the apparatus connected to the OTG portable device;
switching the status of a charging device of the OTG portable device to be off while no Vbus is detected in the apparatus connected to the OTG portable device;
switch on the charging device of the OTG portable device while a Vbus is detected in the apparatus connected to the OTG portable device.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram showing a charging device of an OTG portable device according to a preferred embodiment of the invention.

FIG. 2 is a flowchart of the method for charging an OTG portable device according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

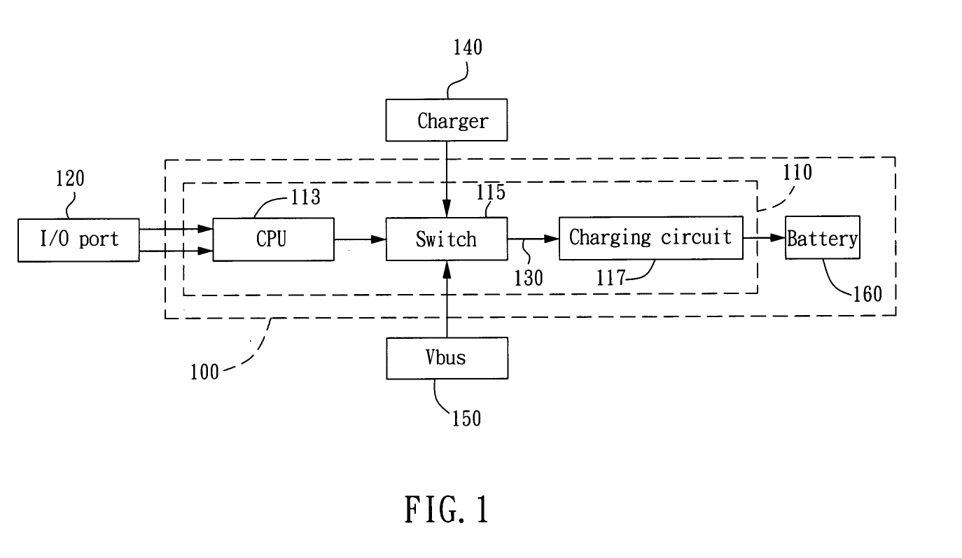

Please refer to FIG. 1, which is a schematic diagram showing a charging device of an OTG portable device according to a preferred embodiment of the invention. The charging device 110 of an OTG portable device of FIG. 1 is composed of a center processing unit (CPU) 113, a charging circuit 117 and a switch 115.

Wherein, the CPU 113 is employed as the control unit of the whole charging device 110, that it can detect and determine the specification of the device being connected thereto according to the data signal 125 transmitted from the I/O port 120 of the OTG portable device 100, that is, the CPU can recognize and thus identify the apparatus connected to the OTG portable device 100 as an OTG A-Device, an OTG B-Device or a PC. As soon as the specification of the apparatus connected to the OTG portable device 100 is recognized and identified by the CPU 113, the switch 115 is activated to set the status of the charging device to be either on or off accordingly. When the status of the charging device 110 is on, power signal 130 can be provided either from a charger 140 or from a Vbus of the I/O port 120 for charging the battery 160 of the OTG portable device 100.

From the above description, it is noted that, as the OTG portable device 100 is connected to another device through the I/O port 120, the battery 160 of the OTG portable device 100 can be charged by the power signal 130 provided form either the Vbus of the I/OP port 120 or the charger 140 according to the operation of the charging device 110.

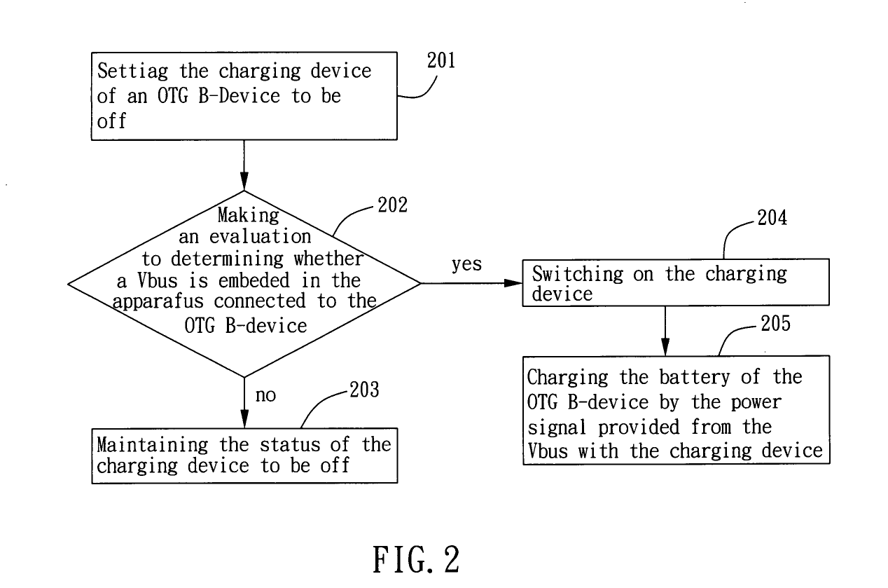

Please refer to FIG. 2, which is a flowchart of the method for charging an OTG portable device according to a preferred embodiment of the invention. In the preferred embodiment of FIG. 2, the OTG portable device is an OTG B-Device (i.e. an USB peripheral), such as a digital camera, being connected to a PC acted as an USB host. The flowchart starts from step 201. In step 201, the status of the charging device of the OTG B-Device is set to be off, and the flow proceeds to step 202.

In step 202, an evaluation is made to determine whether a Vbus is embedded in the apparatus connected to the OTG B-Device; if so, the flow proceeds to step 204, otherwise, the flow proceeds to step 203. In step 203, the status of the charging device of the OTG B-Device is maintained to be off since the apparatus connected thereto does not has a Vbus embedded therein. In step 204, the charging device of the OTG B-Device is switched on since the apparatus connected thereto, which has a Vbus embedded therein, is being identified as an OTG A-Device, and the flow proceeds to step 205.

In step 205, the battery of the OTG B-Device is charged the power signal provided from the Vbus of the apparatus connected thereto through the operation of the charging device of the OTG B-Device of the invention.

Comparing to the prior arts, the present invention has advantages as following:
(a) When an USB enabled PC acted as a host is connected to the USB OTG embedded digital camera, which is now acted as an OTG B-Device, for accessing the images stored therein, the power of the battery of the digital camera is still being exhausted while being charged by the power provided from the PC, so that while a large amount of images are being transfer from the digital camera to the PC, the battery of the digital camera are not likely to drain.
(b) When an USB device is acted as an OTG A-device and is connected to a peripheral having Vbus embedded therein, the USB device acted as an OTG A-device can be charged by the peripheral, by which the means for charging the OTG portable device of the invention are diversified.

Therefore, the present invention can provide a device and method for charging an OTG portable device, which is capable of charging the OTG portable device no matter it is acting as an OTG A-Device or as an OTG B-Device since the OTG portable device is able to change the status of the charging device thereof according to an operation performed by a control unit thereof for detecting whether there is a power signal provided from a Vbus of an apparatus connected to the I/O port of the OTG portable device, and consequently, the means for charging the OTG portable device of the invention are diversified.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A device for charging an OTG portable device, comprising:
a switch, for receiving a plurality of power signals from various external power sources and selectively outputting a power signal selected form the plural power signals;
a charging circuit, for receiving the power signal outputted from the switch while using the same for charging a battery of the OTG portable device; and
a control unit, for receiving an external data signal so as to control the selecting of the switch accordingly.

2. The device of claim 1, wherein the power signal is provided via a Vbus.

3. The device of claim 2, wherein the Vbus is embedded in a personal computer.

4. The device of claim 2, wherein the Vbus is embedded in another OTG portable device.

5. The device of claim 1, wherein the power signal is provided from an adapter.

6. The device of claim 1, wherein the control unit is the center processing unit of the OTG portable device.

7. A method for charging an OTG portable device, comprising:
making an evaluation to determine whether a Vbus is embedded in the apparatus connected to the OTG portable device;
switching the status of a charging device of the OTG portable device to be off while no Vbus is detected in the apparatus connected to the OTG portable device; and
switch on the charging device of the OTG portable device while a Vbus is detected in the apparatus connected to the OTG portable device.

8. The method of claim 7, further comprising the step of:
previously setting the status of charging device of the OTG portable device to be off.

9. The method of claim 7, further comprising the step of:
charging the battery of the OTG B-Device by the power signal provided from the Vbus of the apparatus connected thereto with the charging device
